(19) United States
(12) Patent Application Publication
(10) Pub. No.: US 2005/0162503 A1
(43) Pub. Date: Jul. 28, 2005

(54) Thermal image forming apparatus and method

(76) Inventors: Jong-sung Jung, Suwon-si (KR); Heon-soo Park, Seongnam-si (KR)

Correspondence Address: STANZIONE & KIM, LLP, 1740 N STREET, N.W., FIRST FLOOR, WASHINGTON, DC, 20036, US

(21) Appl. No.: 11/042,137

(22) Filed: Jan. 26, 2005

(30) Foreign Application Priority Data
Jan. 27, 2004 (KR) 2004-4982

(51) Int. Cl. B41J 2/325; B41J 11/00

(52) U.S. Cl. 347/175

(57) ABSTRACT

A thermal image forming apparatus and method of printing a color image by heating a medium having ink layers that react with heat to represent different colors with a single thermal printhead (TPH), includes transferring the medium in a first direction, heating a first surface of the medium using the TPH to represent an image of one or more ink layers, moving a holding unit to an inlet of the TPH in a state where a terminal portion of the medium is engaged with the holding unit installed at an outlet of the TPH to dispose a second surface of the medium to face the TPH, and heating the second surface of the medium to represent an image of the remaining one or more ink layers.

### CROSS-REFERENCE TO RELATED APPLICATIONS

This application claims the priority of Korean Patent Application No. 20044982, filed on Jan. 27, 2004, in the Korean Intellectual Property Office, the disclosure of which is incorporated herein in its entirety by reference.

### BACKGROUND OF THE INVENTION

1. Field of the Invention

The present invention relates to an image forming apparatus and method, and more particularly, to a thermal image forming apparatus and method using a both-side thermal transfer medium.

2. Description of the Related Art

In a conventional image forming method using thermal transfer, ink coated on an ink ribbon is heated using a thermal printhead in a state where a film-shaped ribbon closely adheres to a medium at a predetermined pressure, so that the ink is sublimated and transferred to the medium. As an example of a thermal transfer printer, U.S. patent Publication No. 2003-71887 discloses a printer.

In general, the ink ribbon is supplied in a form of a cassette. The cassette includes a feeding core around which an unused ribbon is wound, a winding core around which used ribbon is wound, and a housing in which the feeding core and the winding core are received.

For example, an ink ribbon of a color thermal transfer printer has a structure in which cyan, yellow, magenta, and black areas are repeatedly and consecutively formed. Thus, when a color image is formed using the ink ribbon, a medium should be transferred repeatedly four times to correspond to each area of the ink ribbon.

Since a conventional color image forming method required a plurality of circulation of the medium, it takes too much long time to form the color image. In addition, the medium and the ink ribbon or the cassette in which the ink ribbon is received, are needed. The medium and the cassette are expandables (consumables) and cause an economic burden. In addition, a mechanism for transferring and driving an individual medium and a cassettes is needed. In particular, a complicated medium transferring mechanism for circulating the medium a plurality of times is needed. Because of a complicated structure for transferring and driving the medium and the cassette, a structure of a thermal transfer image forming apparatus becomes complicated, the degree of freedom of design is lowered, and manufacturing costs increases.

### SUMMARY OF THE INVENTION

In order to solve the foregoing and/or other problems, it is an aspect of the present general inventive concept to provide a thermal image forming apparatus to form an image by heating first and second surfaces of a medium having ink layers that react with heat and represent images having different colors.

It is another aspect of the present general inventive concept to provide a thermal image forming apparatus to form an image by heating a first and a second surfaces of a medium using a thermal printhead (TPH).

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a thermal image forming method of printing a color image by heating a medium having ink layers that react with heat and represent different colors with a single thermal printhead (TPH). The method may include transferring the medium in a first direction, heating a first surface of the medium using the TPH to represent an image of one or more ink layers, moving a holding unit to an inlet of the TPH in a state where a terminal portion of the medium is engaged with the holding unit installed at an outlet of the TPH, so that a second surface of the medium faces the TPH, and heating the second surface of the medium to represent an image of the remaining one or more ink layers.

In an aspect of the present general inventive concept, the holding unit may revolve around the TPH and may be placed at the outlet of the TPH so that the second surface of the medium faces the TPH.

In another aspect of the present general inventive concept, the holding unit may move to the outlet of the TPH, may be placed at the outlet of the TPH, and may rotate so that the second surface of the medium faces the TPH.

The foregoing and/or other aspects and advantages of the present general inventive concept, may also be achieved by providing a thermal image forming apparatus to print a color image using a medium having ink layers that react with heat and represent different colors. The apparatus may include a thermal printhead (TPH), a platen to press the medium against the TPH, and a holding unit comprising a feeding roller and a pressing roller being engaged with each other, wherein the holding unit is installed to race (move) around the TPH.

The foregoing and other aspects and advantages of the present general inventive concept may also be achieved by providing a thermal image forming apparatus to print a color image using a medium having ink layers that react with heat and represent different colors, the apparatus including a thermal printhead (TPH), a platen to press the medium on the TPH, and a holding unit comprising a feeding roller and a pressing roller engaged with each other to move to an inlet and an outlet of the TPH and to rotate with respect to the TPH.

In aspect of the present general inventive concept, the holding unit may serve as a transferring unit to transfer the medium at a printing speed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 and 2 show a structure of a thermal image forming apparatus according to an embodiment of the present general inventive concept;

FIGS. 3 and 4 show a structure of a thermal image forming apparatus according to another embodiment of the present general inventive concept; and

FIGS. 5A through 5E respectively show a thermal image forming method according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A medium used with a thermal image forming apparatus will be described below. The medium may have ink layers that react with heat and represent (produce or form) images having different colors. The ink layers of the medium may react with heat on both sides (first and second surfaces) to represent a predetermined color. Each ink layer may have a single-layer structure using a single color ink or a multilayer structure to represent two or more colors. For example, an ink layer formed on the first surface may have a structure in which two layers to represent yellow and magenta colors are stacked, and another ink layer formed on the second surface may have a single-layer structure to represent a cyan color. In this case, a substrate between both sides on which the ink layers are to be formed is made of a transparent material. U.S. patent Publication No. 2003/0125206 discloses an example of a medium having a plurality of ink layers. An image forming method and a thermal image forming apparatus using the method according to an aspect of the present general inventive concept is not limited to a stack of ink layers formed on the first and second surfaces, respectively.

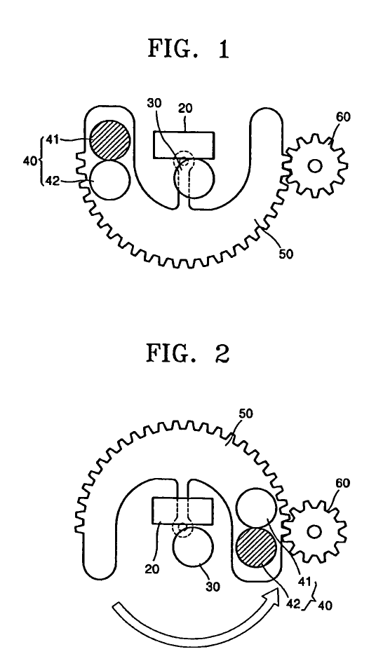

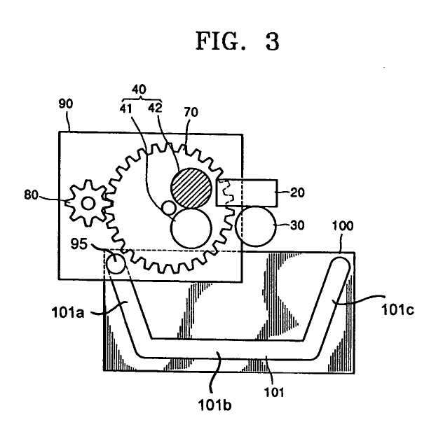

FIGS. 1 and 2 show a structure of a thermal image forming apparatus according to an embodiment of the present general inventive concept. The thermal image forming apparatus may include a holding unit 49 to race (move) around a thermal printhead (TPH) 20 so that both sides of a medium face the TPH in sequence.

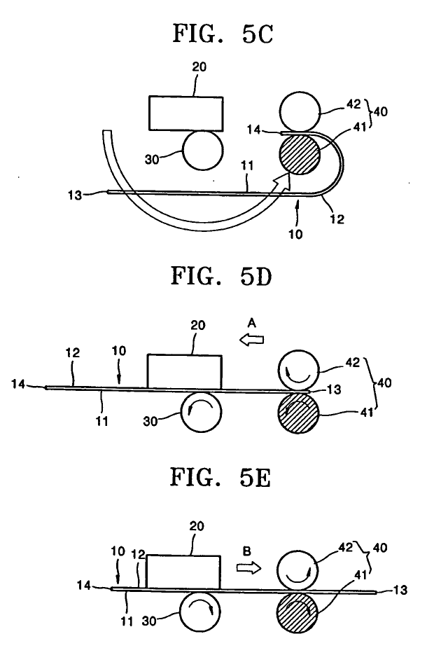

The TPH 20 and a platen 30 are shown in FIGS. 1 and 2. The TPH 20 may have a plurality of heating elements having a fine size arranged at predetermined resolution intervals. The heating elements can be controlled individually to form an image. The platen 30 can be used to press a medium 10 (FIG. 5A) against the TPH 20 so that heat generated by the heating elements is sufficiently transferred to the medium 10. The platen 30 can be in a form of a roller. However, the scope of the present general inventive concept is not limited to the form of the platen 30. The holding unit 40 may include a feeding roller 41 and a pressing roller 42, which are engaged with each other so that the holding unit 40 serves as a transferring unit to transfer the medium 10 at a predetermined printing speed. The feeding roller 41 can be driven by a driving unit (not shown), and the pressing roller 42 can rotate along the feeding roller 41.

The holding unit 40 can be installed in a first frame 50 having gear teeth formed on an outer circumference. The first frame 50 is installed to be rotated around the TPH 20. In an aspect of the present general inventive concept, a rotational center of the first frame 50 can be a contact point between the TPH 20 and the platen 30. A gear 60 can be used to rotate the first frame 50. Thus, the holding unit 40 revolves around a circumference of the TPH 20 to move between an inlet and an outlet of the TPH 20.

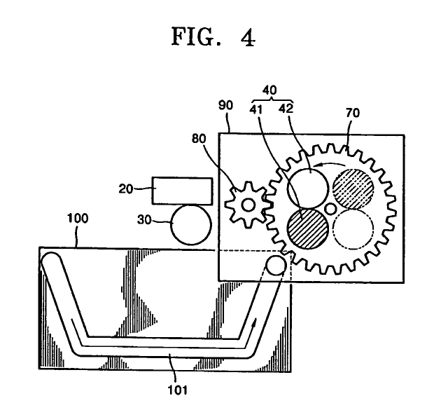

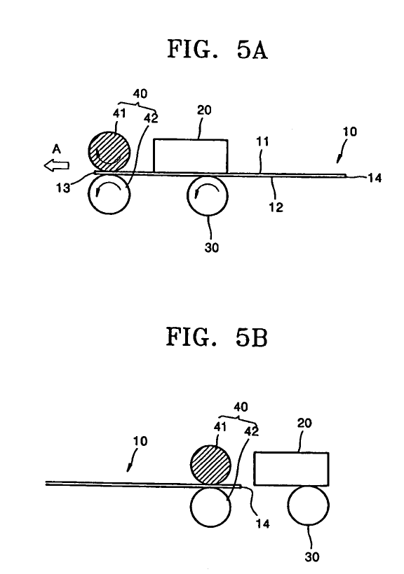

FIGS. 3 and 4 show a structure of a thermal image forming apparatus according to another embodiment of the present general inventive concept. The thermal image forming apparatus may include a holding unit 40 to move between an inlet and an outlet of a TPH 20 and to rotate with respect to the TPH 20 so that both sides of a medium 10 face the TPH 20 in sequence.

Elements having the same functions as those of the elements shown in FIGS. 1 and 2 refer to same reference numerals, and repeated descriptions will be omitted.

The TPH 20, the platen 30, and the holding unit 40 are shown in FIGS. 3 and 4. The holding unit 40 can be installed in a second frame 70. The second frame 70 can be installed to be rotated in a third frame 90. Gear teeth are formed on a circumference of the second frame 70. A gear 80 can be installed in the third frame 90 to rotate the second frame 70. A path 101 that extends from the outlet of the TPH 20 to the inlet of the TPH 20 can be formed in a fourth frame 100. The third frame 90 can be installed to move to the outlet and inlet of the TPH 20 along the path 101. Thus, the holding unit 40 can be placed at the outlet of the TPH 20, can move to the inlet of the TPH 20, and can be rotated as the second frame 70 is rotated. The path 101 may include a first path 101a, a second path 101b, and a third path 101c, and a pin is installed on the third frame 90 to be inserted into the path 101 so that the third frame 90 moves between the inlet and the outlet of the TPH 20.

An image forming method to be performed in the thermal image forming apparatus of FIGS. 1 and 2 or 3 and 4 according to another embodiment of the present general inventive concept, shown in FIGS. 1 through 4 will now be described with reference to FIGS. 5A through 5E.

Hereinafter, as an example, a case where yellow and magenta ink layers are represented by heating a first surface 11 of a medium and a cyan ink layer is represented by heating a second surface 12 of the medium 10 will be described.

The medium 10 can be supplied by a supplying unit (not shown) between the TPH 20 and the platen 30. As shown in FIG. 5A, a front end 13 of the medium 10 can be engaged with the holding unit 40. In this case, the TPH 20 and the platen 30 may be separated from each other and engaged with each other after the front end 13 of the medium 10 is engaged with the holding unit 40. The holding unit 40 can serve as a transferring unit to transfer the medium 10. The holding unit 40 can transfer the medium 10 in a direction of an arrow A (first direction) at a predetermined printing speed. The plurality of heating elements of the TPH 20 can be controlled to be turned on or off according to image information. For example, when a yellow color is represented, the heating elements can be heated at a high temperature for a short time, and when a magenta color is represented, the heating elements can be heated at a low temperature for a longer time. Then, yellow and magenta images can be printed on a first surface 11 of the medium 10.

As shown in FIG. 5B, the holding unit 40 can stop transferring the medium 10 before a terminal portion 14 of the medium 10 is deviated from the holding unit 40.

According to the image forming apparatus shown in FIGS. 1 and 2, the holding unit 40 can revolve around the TPH 20 and can be placed at the inlet of the TPH 20. According to the image forming apparatus shown in FIGS. 3 and 4, the holding unit 40 can move to the inlet of the TPH 20 while rotating. The holding unit 40 may move to the inlet of the TPH 20 after rotating at the outlet of the TPH 20 or may move and rotate at the same time. In this case, the terminal portion 14 of the medium 10 can be engaged with the holding unit 40. Thus, as shown in FIG. 5C, the second surface 12 of the medium 10 can face the TPH 20, and the terminal portion 14 thereof disposed at the inlet of the TPH 20.

In an aspect of the present general inventive concept, the medium 10 can move in the direction of the arrow A (first direction), the second surface 12 of the medium 10 can be heated, an ink layer having a cyan color is represented so that a color printing operation is performed. In this case, a printing operation starts to be performed on the terminal portion 14 of the medium 10. In another aspect of the present general inventive concept, as shown in FIG. 5D, the medium 10 can be transferred in the direction of the arrow A (first direction) until the front end of the medium 10 printed with the image on the first surface 11 thereof reaches a printing start location of the TPH 20, that is, a location in which the platen 30 and the TPH 20 contact each other. Then, as shown in FIG. 5E, the medium 10 can be transferred in a direction of an arrow B (second direction), the second surface 12 of the medium 10 can be heated, and the ink layer having the cyan color can be represented.

By performing the above-described method, images of yellow and magenta colors printed on the first surface 11 of the medium 10 and an image of a cyan color printed on the second surface 12 of the medium 10 can be superimposed on one another such that a color image is formed.

The images of the yellow and magenta colors printed on the first surface 11 of the medium 10 and the image of the cyan color printed on the second surface 12 of the medium 10 can be printed to be correctly (precisely) superimposed on one another so that the yellow, magenta, and cyan colors are correctly superimposed on one another to obtain a color image having a desired color. However, when the color image is formed by heating the both sides of the medium 10 in sequence, it may be very difficult to form an image having each color at a correct location. However, according to the above-described thermal image forming apparatus and method, the medium 10 can always be engaged with the holding unit 40 during the printing operation. That is, when the second surface 12 faces the TPH 20 after the image is printed on the first surface 11, the terminal portion 14 of the medium 10 can be engaged with the holding unit 40 such that the location of the medium 10 with respect to the holding unit 40 is not changed. Thus, the image can be correctly superimposed and printed on the first surface 11 and the second surface 12 of the medium 10. In particular, as shown in FIGS. 1 through 4, when the holding unit 40 serves as the transferring unit to transfer the medium 10 at a predetermined printing speed, a transfer precision of the medium 10 can further be improved such that a higher quality image is obtained.

In the above-described embodiments, color images having different colors can be formed on both sides of the medium 10 so that a complete color image is formed in view of one side of the medium 10. In the thermal image forming apparatus and method according to an embodiment of the present general inventive concept, in a case of a medium having each single-color ink layer formed on both sides of an opaque material, images having different information can also be printed on both sides of the medium.

As described above, in the thermal image forming apparatus and method according to embodiment of the present general inventive concept, an image can be printed on both sides of the medium using a TPH. In addition, the transfer precision of the medium can be improved such that a higher quality image is obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A thermal image forming method of printing a color image by heating a medium having ink layers that react with heat and represent different colors with a single thermal printhead (TPH), the method comprising:
transferring a medium in a first direction to heat a first surface of the medium using a TPH to represent a first image of one or more ink layers;
moving a holding unit from the outlet of the TPH to the inlet of the TPH in a state where a terminal portion of the medium having the first surface with the first image is engaged with the holding unit to dispose a second surface of the medium to face the TPH; and
heating the second surface of the medium to represent a second image of one more ink layers.

2. The method of claim 1, wherein the moving of the holding unit comprises controlling the holding unit to revolve around the TPH so that the second surface of the medium faces the TPH.

3. The method of claim 1, wherein the moving of the holding unit comprises controlling the holding unit to move from the outlet of the TPH to the inlet of the TPH and rotate on its own axis at the inlet of the TPH so that the second surface of the medium faces the TPH.

4. The method of claim 1, wherein after the medium is transferred in the first direction so that a front end of the image formed on the first surface is placed at a printing start location of the TPH, the medium is transferred in a second direction and the second surface of the medium is heated so that an image of the remaining ink layers is represented.

5. The method of claim 1, wherein the holding unit includes a feeding roller and a pressing roller, which are pressed with each other and rotated to transfer the medium.

6. A thermal image forming apparatus to print a color image using a medium having ink layers that react with heat to represent different colors, the apparatus comprising:
a thermal printhead (TPH) having an inlet and an outlet;
a platen to transfer a medium while pressing the medium against the TPH; and
a holding unit installed at the outlet of the TPH to hold the medium having a first surface formed with a first image, and to move to the inlet of the TPH to dispose a second surface of the medium to face the TPH to form a second image.

7. The apparatus of claim 6, wherein the holding unit comprises a transferring unit to transfer the medium at a printing speed.

8. The apparatus of claim 6, wherein the holding unit comprises a feeding roller and a pressing roller to receive the medium having the first surface formed with the first image from the outlet of the TPH and to transfer the medium toward the inlet of the TPH.

9. The apparatus of claim 8, wherein the holding unit comprises a frame in which the feeding and pressing rollers are rotatably installed, and the frame rotates around a rotation center to move between the inlet and the outlet of the TPH.

10. The apparatus of claim 9, wherein the rotation center is disposed between the inlet and outlet of the TPH.

11. The apparatus of claim 9, wherein the rotation center is disposed on a line having a contact point between the TPH and the platen.

12. The apparatus of claim 9, wherein the frame of the holding unit comprises a structure formed in a circular direction around the TPH and having gear teeth formed on a circumference thereof, and the holding unit comprise a gear to be engaged with the gear teeth to rotate the frame around the TPH.

13. The apparatus of claim 6, wherein the holding unit revolves around a circumference of the TPH to move between the inlet and the outlet of the TPH.

14. The apparatus of claim 6, wherein the holding unit rotates the medium so that the first and second surfaces of the medium face the TPH in sequence.

15. The apparatus of claim 6, wherein the medium is transferred in a first direction when the first image is formed an the first surface of the medium by the TPH, and the holding unit comprises a feeding and a pressing rollers arranged in a second direction perpendicular to the first direction when the holding unit is disposed in a position to correspond to the outlet of the TPH, and arranged in a third direction opposite to the second direction when the holding unit is disposed in a second position to correspond to the inlet of the TPH.

16. The apparatus of claim 6, wherein the holding unit comprises a first frame in which a feeding and a pressing rollers are rotatably installed, a second frame in which the first frame is installed, a gear to rotate the first frame, a third frame having a path along which the second frame moves to dispose the second frame in either one of a first position to correspond to the inlet of the TPH and a second position to correspond to the outlet of the TPH.

17. The apparatus of claim 6, wherein the holding unit receives a front portion of the medium in a first direction from the outlet of the TPH, holds a terminal portion of the medium, moves the medium around the TPH from the outlet to the inlet of the TPH while holding the terminal position, and transfers the terminal portion of the medium toward the TPH.

18. The apparatus of claim 6, wherein the holding unit comprises a feeding and a pressing rollers to rotate around the TPH while holding the medium therebetween.

19. The apparatus of claim 18, wherein the feeding and pressing rollers have rotation centers disposed on a line perpendicular to a first direction in which the medium is transferred to pass the TPH.

20. The apparatus of claim 19, wherein the feeding and pressing rollers are arranged in a second direction when the holding unit is disposed at the outlet of the TPH and in a third direction opposite to the second direction when the holding unit is disposed at the inlet of the medium.

21. A thermal image forming apparatus to print a color image using a medium having ink layers that react with heat and represent different colors, the apparatus comprising:
a thermal printhead (TPH) having an inlet and an outlet;
a platen pressing the medium on the TPH; and
a holding unit comprising a feeding roller and a pressing roller to receive the medium from the outlet of the TPH and to hold the medium, and moving between the inlet and the outlet of the TPH while rotating on it own axis so that a first surface of the medium faces the TPH when the holding unit is disposed at the outlet of the medium, and a second surface of the medium faces the TPH when the holding unit is disposed at the inlet of the medium.
